(19) United States
(12) Patent Application Publication
(10) Pub. No.: US 2007/0097548 A1
(43) Pub. Date: May 3, 2007

(54) Perpendicular magnetic recording apparatus

(75) Inventor: Tomoko Taguchi, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/589,724

(22) Filed: Oct. 31, 2006

(30) Foreign Application Priority Data
Oct. 31, 2005 (JP) 2005-317525

(51) Int. Cl. G11B 5/147

(52) U.S. Cl. 360/126

(57) ABSTRACT

According to one embodiment, a perpendicular magnetic recording apparatus includes a write head including a main pole, a return pole and an exciting coil, and a medium having a soft underlayer and a perpendicular recording layer on a substrate, in which the main pole has a length P in a down-track direction longer than a length T in a cross-track direction at a trailing edge, and has a leading edge recessed from a trailing edge on an air-bearing surface, and in which a gap G between the main pole and the return pole is smaller than twice a distance S between the air-bearing surface of the write head and a surface of the soft underlayer of the medium.

### CROSS-REFERENCE TO RELATED APPLICATIONS

This application is based upon and claims the benefit of priority from Japanese Patent Application No. 2005-317525, filed Oct. 31, 2005, the entire contents of which are incorporated herein by reference.

### BACKGROUND

1. Field

One embodiment of the present invention relates to a perpendicular magnetic recording apparatus.

2. Description of the Related Art

The magnetic recording apparatus poses a problem of side-write in which an adjacent track is written in the case where a recording head has a large skew angle relative to the traveling direction thereof.

U.S. Pat. No. 6,710,973 discloses a technique to taper the leading edge of the main pole in order to obviate the side write problem in a perpendicular magnetic recording apparatus. In the perpendicular magnetic recording apparatus comprising a write head including such a main pole combined with a perpendicular double-layer medium including a soft underlayer and a perpendicular recording layer, the main pole and the soft underlayer have considerably large coupling with each other. In order to suppress the recording on the leading side of the main pole, therefore, the taper angle on the leading side of the main pole is required to be increased. In such a case, however, the magnetic strength on the trailing side of the main pole also decreases, and therefore the recording signal quality is degraded, thereby making it impossible to improve the linear recording density.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a cross-sectional view showing a magnetic head and a perpendicular recording medium installed in a perpendicular magnetic recording apparatus according to an embodiment of the present invention;

FIG. 2 is a plan view of the magnetic head of FIG. 1 as viewed from the air-bearing surface;

FIG. 3 is a diagram showing a shape of a main pole of a conventional perpendicular magnetic recording apparatus as viewed from the ABS and a magnetization pattern recorded on the medium by the main pole;

FIG. 4 is a diagram showing a state of side-write by the main pole of the conventional perpendicular magnetic recording apparatus when a skew angle θ is formed;

FIG. 5 is a diagram showing a shape of a main pole according to an embodiment of the present invention as viewed from the ABS and a magnetization pattern recorded on the medium by the main pole;

FIG. 6 is a diagram showing a state of side-write by the main pole of the perpendicular magnetic recording apparatus according to the embodiment of the present invention when a skew angle θ is formed;

FIG. 7A is a graph showing the relationship between a value of G/2S, OW and maximum amount of fringing in a hard disk drive (HDD), FIG. 7B is a diagram showing an example of a shape of a main pole under a condition of G≦2S as viewed from the ABS and a magnetization pattern recorded on the medium, and FIG. 7C is a diagram showing an example of a shape of a main pole under a condition of G>2S as viewed from the ABS and a magnetization pattern recorded on the medium;

FIG. 8 is a cross-sectional view of a magnetic head and a perpendicular recording medium installed in a perpendicular magnetic recording apparatus according to another embodiment of the present invention;

FIG. 9 is a diagram showing the relationship between track pitch and fringing assuming that a main pole has a constant physical shape as viewed from the ABS;

FIG. 10 is a diagram showing the relationship between track pitch and length of main pole which brings about constant fringing; and

FIG. 11 is a diagram showing the relationship between track pitch and quality of recording signal.

### DETAILED DESCRIPTION

Various embodiments according to the invention will be described hereinafter with reference to the accompanying drawings. In general, according to one embodiment of the present invention, there is provided a perpendicular magnetic recording apparatus comprising: a write head including a main pole, a return pole and an exciting coil; and a medium having a soft underlayer and a perpendicular recording layer on a substrate, the main pole having a length P in a down-track direction longer than a length T in a cross-track direction at a trailing edge, and having a leading edge recessed from a trailing edge on an air-bearing surface, and a gap G between the main pole and the return pole being smaller than twice a distance S between the air-bearing surface of the write head and a surface of the soft underlayer of the medium.

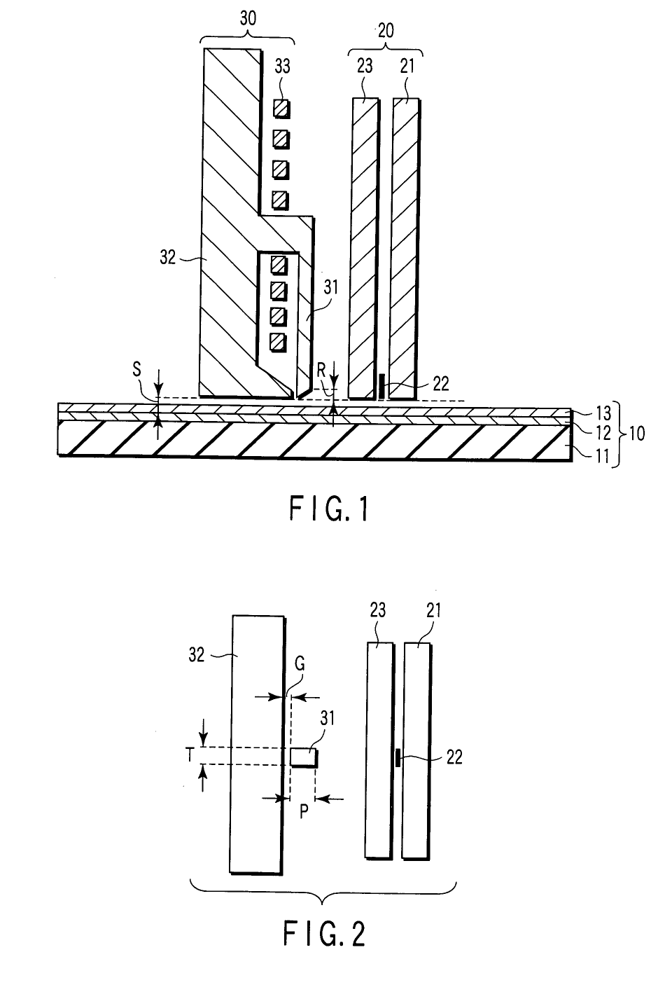

FIG. 1 is a cross-sectional view showing a magnetic head and a perpendicular recording medium installed in a perpendicular magnetic recording apparatus according to an embodiment of the invention, and FIG. 2 is a plan view of the magnetic head of FIG. 1 as viewed from the air-bearing surface (ABS).

The medium (magnetic disk) 10 is a perpendicular double-layer medium including the soft underlayer 12 and the perpendicular recording layer 13 having magnetic anisotropy in the direction perpendicular to the film plane on the substrate 11.

The magnetic head is of a type in which the read head 20 and the write head 30 are separated. The read head 20 includes the magnetoresistive film 22 and magnetic shields 21, 23 arranged on the trailing and leading sides in such a manner as to sandwich the magnetoresistive film 22. The write head 30 includes the main pole 31, the return pole 32 arranged on the trailing side of the main pole 31 and the exciting coil 33 wound on the magnetic path constituted by the main pole 31 and the return pole 32. The main pole 31 is formed of a high permeability material capable of generating a magnetic field in the direction perpendicular to the disk surface. The return pole 32 serves to close the magnetic path efficiently via the soft underlayer 12 immediately under the main pole 31. Magnetic fluxes are made to flow in the main pole 31 by the exciting coil 33.

As shown in FIG. 2, the main pole 31 has such a shape on the ABS that the length P in the down-track direction is longer than the length T in the cross-track direction at the trailing edge. Also, as shown in FIG. 1, the main pole 31 has the leading edge recessed from the trailing edge on the ABS. Further, the gap G between the main pole 31 and the return pole 32 is smaller than twice the distance S between the ABS of the write head 30 and the surface of the soft underlayer 12 of the medium 10.

In the conventional perpendicular magnetic recording apparatus, on the other hand, the gap G between the main pole 31 and the return pole 32 is larger than twice the distance S between the ABS of the write head 30 and the surface of the soft underlayer 12 of the medium 10.

The effects of the perpendicular magnetic recording apparatus according to an embodiment of the invention as compared with the conventional perpendicular magnetic recording apparatus are described below. In both apparatuses, the main pole is designed to have an amount of recess R of the leading edge relative to the trailing edge on the ABS 0.4 times the length P in the down-track length, i.e., R is set to 0.4 P.

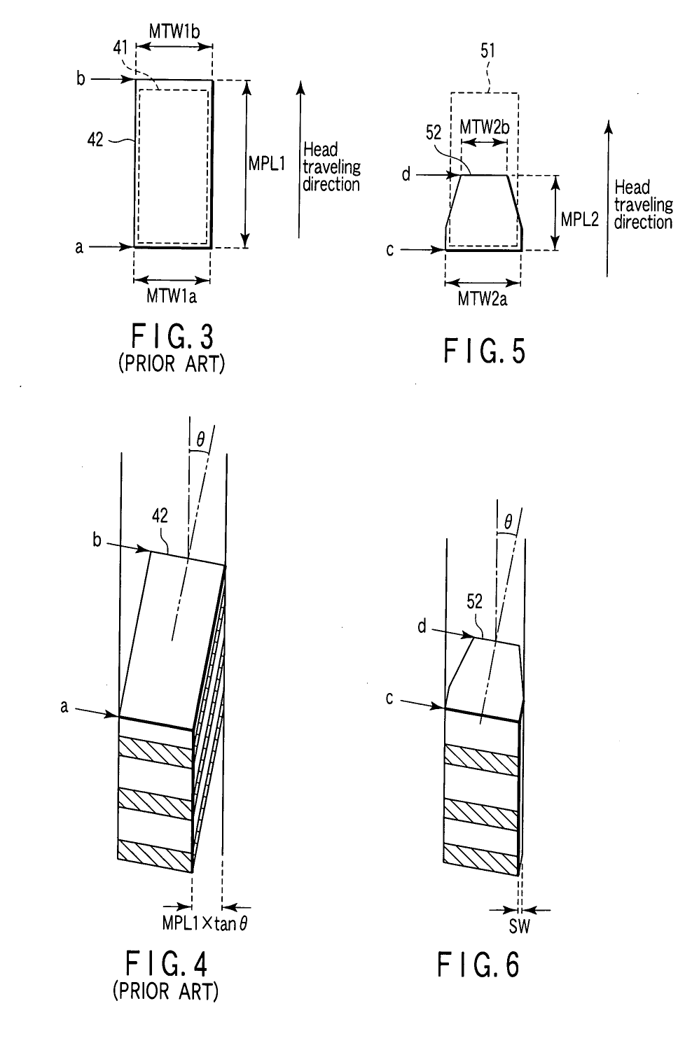

First, the conventional perpendicular magnetic recording apparatus will be described. FIG. 3 is a diagram showing a shape of a main pole of a conventional perpendicular magnetic recording apparatus as viewed from the ABS and a magnetization pattern recorded on the medium by the main pole. FIG. 4 is a diagram showing a state of side-write by the main pole of the conventional perpendicular magnetic recording apparatus when a skew angle θ is formed.

In FIG. 3, the dashed line 41 indicates the shape of the main pole 31 as viewed from the ABS, and the solid line 42 indicates the magnetization pattern recorded on the medium by the main pole 31. The magnetization pattern (solid line 42) on the medium has a rectangular shape substantially equal to the rectangular shape (dashed line 41) of the main pole 31 as viewed from the ABS. In FIG. 3, the position a is the trailing edge of the magnetization pattern, and the position b is the leading edge of the magnetization pattern. Here, the magnetic track width MTW1a denotes the width of the magnetization pattern at the trailing edge and the magnetic track width MTW1b denotes the width of the magnetization pattern at the leading edge. MTW1b is substantially equal to MTW1a. The distance between positions a and b is defined as the magnetic pole length MPL1 of the magnetization pattern on the medium.

As shown in FIG. 4, in the case where the main pole forms the skew angle θ in the perpendicular magnetic recording apparatus, the side-write occurs with the width of (MPL1×tanθ).

Next, the perpendicular magnetic recording apparatus according to the embodiment will be described. FIG. 5 is a diagram showing a shape of a main pole according to the embodiment of the present invention as viewed from the ABS and a magnetization pattern recorded on the medium by the main pole. FIG. 6 is a diagram showing a state of side-write by the main pole of the perpendicular magnetic recording apparatus according to the embodiment of the present invention when the skew angle θ is formed.

In FIG. 5, the dashed line 51 indicates the shape of the main pole 31 as viewed from the ABS, and the solid line 52 indicates the magnetization pattern recorded on the medium by the main pole 31. As compared with the rectangular shape (dashed line 51) of the main pole 31 as viewed from the ABS, the magnetization pattern (solid line 52) on the medium forms a polygon having a smaller length (MPL2<MPL1) and smaller width on the leading side. In FIG. 5, the position c is the trailing edge of the magnetization pattern, and the position d is the leading edge of the magnetization pattern. Specifically, if the magnetic track width MTW2a denotes the width of the magnetization pattern at the trailing edge and the magnetic track width MTW2b denotes the width of the magnetization pattern at the leading edge, MTW2b is smaller than MTW2a (MTW2b<MTW2a). The distance between the positions c and d is defined as the magnetic pole length MPL2 of the magnetization pattern on the medium.

As shown in FIG. 6, even in the case where the main pole forms the skew angle θ in the perpendicular magnetic recording apparatus, the side-write (SW) is considerably suppressed as compared with the case of FIG. 4. This is due to the fact that the following conditions are established: MPL2<MPL1, and MTW2b<MTW2a. In this way, with the perpendicular magnetic recording apparatus according to the embodiment, the side-write can be suppressed even in the case where the main pole forms the skew angle θ, and therefore the track pitch is effectively improved.

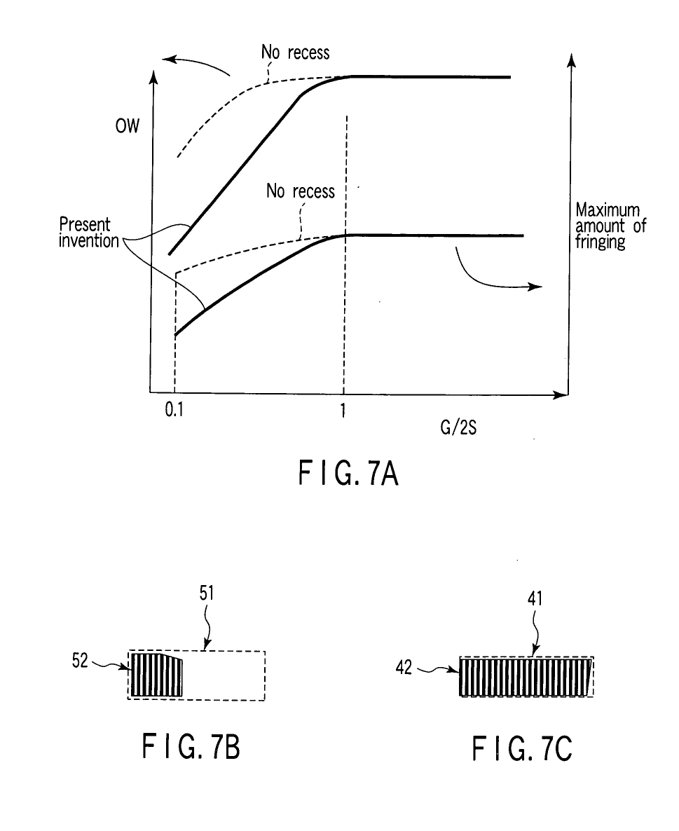

Next, a more detailed description is given about the reason why the gap G between the main pole 31 and the return pole 32 and the distance S between the ABS of the write head and the surface of the soft underlayer of the medium desirably satisfy the following condition: G≦2S. FIG. 7A shows a graph showing the relationship between a value G/2S, overwrite characteristics OW and a maximum amount of fringing in hard disk drive (HDD). OW is an indicator of the write ability and indicates the amount of the high-frequency signal erased with the low-frequency signal recording effected after the high-frequency signal recording. The diagram shows the result of using the main pole in which the ratio between the length P in the down-track direction and the amount of recess R of the leading edge relative to the trailing edge is set to 0.8, i.e., R/P is set to 0.8. FIG. 7B is a diagram showing an example of a shape of a main pole under a condition of G≦2S as viewed from the ABS and a magnetization pattern recorded on the medium. FIG. 7C is a diagram showing an example of a shape of a main pole under a condition of G>2S as viewed from the ABS and a magnetization pattern recorded on the medium.

In the case where G>2S, even with the leading edge of the main pole recessed, more magnetic fluxes from the main pole flow into the soft underlayer of the medium. As a result, as shown in FIG. 7C, the magnetization pattern recorded on the medium is stamped in substantially the same shape as that of the ABS of the main pole. In such a case, when the main pole forms a skew angle in the HDD, the maximum amount of fringing (corresponding to side-write) is so large that OW is not improved.

In the case where G≦2S as defined in the present invention, in contrast, as long as the leading edge of the main pole is recessed, all the magnetic fluxes of the main pole do not flow into the soft underlayer of the medium, but a part of them flow into the return pole. The amount of magnetic fluxes flowing from the main pole into the return pole increases with the decrease in the gap G. With the decrease in the amount of magnetic fluxes flowing into the soft underlayer of the medium from the recessed leading edge, as shown in FIG. 7B, the magnetic pole length of the magnetization pattern recorded on the medium becomes considerably smaller than the physical shape of the main pole on the ABS. Even in the case where the main pole forms a skew angle in the HDD, the maximum amount of fringing (corresponding to side-write) can be suppressed and OW is improved. With reference to FIG. 7A, the maximum amount of fringing is compared between the conventional head having no recess and the head according to the present invention. In the range where G/2S is smaller than 1, the maximum amount of fringing of the head according to the present invention is found to be considerably improved over the conventional head (dashed line) having no recess. In the case where G/2S is smaller than 0.1, however, the OW ability is totally lost. Therefore, the following relationship should be satisfied: 0.1<G/2S<1.

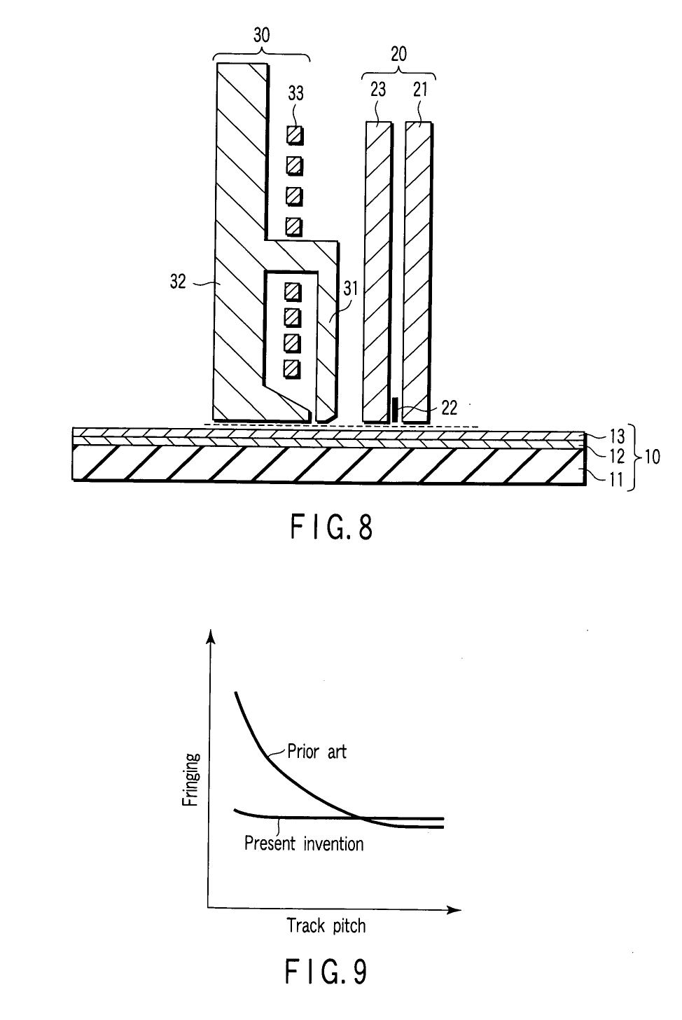

FIG. 8 is a cross-sectional view showing a magnetic head and a perpendicular recording medium installed in a perpendicular magnetic recording apparatus according to another embodiment of the present invention. The embodiment shown in FIG. 8 is different from the embodiment shown in FIG. 1 in that the main pole 31 has, on the ABS, a part parallel with the medium surface in the vicinity of the trailing edge, and the leading side of the particular part is recessed toward the leading edge.

The ABS of the main pole 31 may be rounded. Also, the width of the leading edge may be smaller than the width of the trailing edge on the ABS of the main pole.

Also in these modifications, the magnetic pole length is reduced and the magnetic track width of the leading edge is made smaller than that of the trailing edge. Therefore, even in the case where the main pole forms a skew angle in the perpendicular magnetic recording apparatus, the side-write can be suppressed.

The effects of the perpendicular magnetic recording apparatus according to the embodiments of the invention are summarized below.

With reference to FIG. 9, the first effect of the perpendicular magnetic recording apparatus according to embodiments of the present invention will be described. FIG. 9 shows the relationship between track pitch and fringing assuming that the main pole has a constant physical shape as viewed from the ABS. In the conventional apparatus, the fringing sharply increases with the decrease in track pitch. In the apparatus according to the present invention, on the other hand, the fringing is hardly increased with the decrease in track pitch.

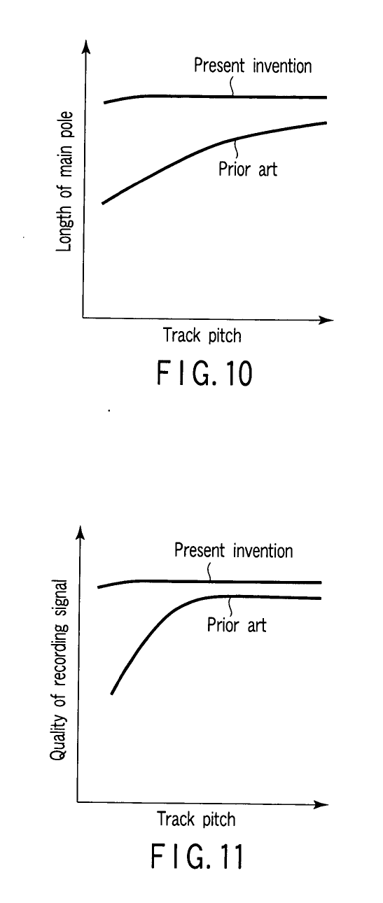

With reference to FIGS. 10 and 11, the second effect of the perpendicular magnetic recording apparatus according to embodiments of the present invention will be described. FIG. 10 shows the relationship between track pitch and length of main pole which brings about constant fringing. In the apparatus according to the present invention, even with a smaller track pitch, the low fringing eliminates the need of reducing the length of the main pole. As a result, magnetic fluxes sufficient for recording can be supplied. FIG. 11 shows the relationship between track pitch and quality of recording signal. As described above, with the apparatuses according to the present invention, since there is no need to reduce the area of the ABS which makes it possible to supply magnetic fluxes sufficient for recording, the quality of recording signal can be maintained even in the case where the track pitch is reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic recording apparatus comprising:
a write head including a main pole, a return pole and an exciting coil; and
a medium having a soft underlayer and a perpendicular recording layer on a substrate,
the main pole having a length P in a down-track direction longer than a length T in a cross-track direction at a trailing edge, and having a leading edge recessed from a trailing edge on an air-bearing surface, and
a gap G between the main pole and the return pole being smaller than twice a distance S between the air-bearing surface of the write head and a surface of the soft underlayer of the medium.

2. The apparatus according to claim 1, wherein the main pole has an amount of recess R of the leading edge relative to the trailing edge on the air-bearing surface smaller than the length P in the down-track direction.

3. The apparatus according to claim 1, wherein it satisfies the following condition: 0.1<G/2S<1.
